(19) United States
(12) Patent Application Publication
(10) Pub. No.: US 2019/0283488 A1
(43) Pub. Date: Sep. 19, 2019

(54) ADHESIVE MARKING DEVICE

(71) Applicant: ADHETEC, Tarbes (FR)

(72) Inventors: Jose Ricardo Samaca Martinez, Tarbes (FR); Willy Agut, Tarbes (FR)

(73) Assignee: ADHETEC, Tarbes (FR)

(21) Appl. No.: 16/301,696

(22) PCT Filed: May 17, 2017
(86) PCT No.: PCT/EP2017/061800

§ 371 Date: Nov. 14, 2018

(30) Foreign Application Priority Data
May 18, 2016 (FR) 1654404
May 18, 2016 (FR) 1654406

(51) Int. Cl. B44C 1/10; C09J 7/20

(52) U.S. Cl. CPC B44C 1/105; B44C 1/1733; C09J 7/20

(57) ABSTRACT

An adhesive marking device generally includes an adhesive layer, a marking layer arranged on the adhesive layer, and a varnish layer that covers the marking layer. The marking layer includes a marking and a carrier film. The marking device generally has a moisture vapour transmission rate (MVTR) greater than or equal to 50 g/(m²·day).

### 1. TECHNICAL FIELD OF THE INVENTION

The invention relates to an adhesive marking device for an aircraft. The invention also relates to a method for manufacturing an adhesive marking device for an aircraft.

### 2. TECHNOLOGICAL BACKGROUND

Many markings must be affixed on the outside as well as on the inside of aircraft for identification, control, safety or decorative purposes. In the context of the invention, the term “marking” means one or several signs such as letter, digit, symbol, drawing, image, etc. These markings can be of any shape and of any size.

In aeronautics, using adhesive marking devices is a favoured solution.

These adhesive marking devices must resist extreme conditions. Indeed, they are subjected to high and very low temperatures, to thermal shocks, moisture and substantial variations in pressure. They are also highly exposed to ultraviolet light.

These adhesive marking devices have to have a low thickness and be applied onto the substrate thereof in such a way as to not create any protrusions. Indeed, the marking must be as thin as possible in order to resist wear better.

In addition, these adhesive marking devices must be able to be affixed quickly and reliably.

### 3. OBJECTIVES OF THE INVENTION

The invention aims to overcome at least some of the disadvantages of the known adhesive marking devices for an aircraft.

In particular, the invention aims to provide, in at least one embodiment, an adhesive marking device for an aircraft that can be arranged on a substrate that has just been painted.

The invention aims to provide, in at least one embodiment of the invention, a marking device that resists the extreme conditions to which aircraft are subjected.

The invention also aims to provide, in at least one embodiment, an adhesive marking device for an aircraft that can be arranged easily and quickly.

The invention also aims to provide, in at least one embodiment, an adhesive marking device for an aircraft that is not very sensitive to wear.

The invention aims to provide, in at least one embodiment of the invention, a marking device that can easily be removed by an operator while still having resistance to the extreme conditions to which aircraft are subjected.

The invention also aims to provide, in at least one embodiment, an adhesive marking device for an aircraft that can be removed from the substrate whereon it is affixed without specific equipment, products or techniques.

The invention also aims to provide, in at least one embodiment, an adhesive marking device for an aircraft that can be quickly removed from the substrate whereon it is affixed.

### 4. DISCLOSURE OF THE INVENTION

To do this, the invention relates to an adhesive marking device for an aircraft comprising:
an adhesive layer
a marking layer arranged on the adhesive layer and comprising a marking and a carrier film, and
a varnish layer that covers the marking layer.

the marking device having a moisture vapour transmission rate (MVTR) greater than or equal to 50 g/(m²·day).

The moisture vapour transmission rate also called MVTR, is measured according to the standard ASTM F1249.

In the following description, the terms above, below, upper, lower and similar are used to define a relationship of order between the various layers or films constituting the marking device according to the invention and/or the respective faces thereof, in reference to an axis normal to the surface of the substrate whereon the marking device must be affixed and oriented from the substrate to the outside of the marking device.

In the field of aeronautics, adhesive marking devices are generally affixed onto a substrate that has just been painted. However, if the adhesive marking device is affixed too quickly on such a substrate, gases coming from the paint are emitted under the marking device. These gases imprisoned under the marking device form bubbles and the marking device becomes wavy in appearance. In addition to the unsightly nature of these bubbles, they create irregularities on the surface of the marking device making it more sensitive to wear. The marking device according to the invention is particularly suited to be affixed onto a substrate that has just been painted. With an MVTR greater than or equal to 50 g/(m²·day), the marking device is sufficiently permeable to allow the gases coming from the desolvation of the paint during the polymerisation to escape and prevent bubbling. By preventing bubbling, the marking in particular is prevented from being damaged by the swelling of the marking device.

Preferably, the marking device has a moisture vapour transmission rate (MVTR) greater than or equal to 60 g/(m²·day), more preferably 70 g/(m²·day), even more preferably 80 g/(m²·day).

According to a preferred embodiment, the marking device has an MVTR between 50 and 1500 g/(m²·day). At this range of MVTR, the marking device is sufficiently permeable to allow the gases coming from the paint to escape while still retaining an increased resistance to the extreme conditions to which aircraft are subjected. In order to have a marking device with an optimum resistance in particular when it is intended to be affixed on the outside of an aircraft, it is preferable that the latter have an MVTR that is less than 700 g/(m²·day), more preferably less than 500 g/(m²·day).

Preferably, the adhesive marking device is intended to be affixed to the outside of an aircraft, for example on the fuselage. The marking device according to the invention is particularly suited to the extreme conditions to which the fuselage of an aircraft is subjected. In addition, the marking device does not become wavy in appearance, it is not very sensitive to the phenomenon of wear.

According to a preferred embodiment, the marking device is able to be stripped by a stripping agent. It can be necessary to remove a marking device for example in order to change it or when the aircraft has to be repainted. The marking devices must therefore both resist the extreme conditions to which they are subjected and be easy to remove as soon as the operator so desires. These devices are generally removed mechanically by the operators which is long and meticulous. The marking devices according to the invention are able to be stripped. As such, they can easily be removed by a stripping agent. The removal of the marking device is in particular required during the stripping of the aircraft whereon it is affixed. An aircraft is stripped every 5 to 10 years for aesthetic reasons, but also to respond to the normal wear of the paint. According to this embodiment, the removal of the marking device can be done at the same time as the stripping of the paint of the aircraft is carried out, for example with conventional stripping agents or with an intermediate layer, without this requiring an additional step.

Typically, the stripping agent is a chemical stripping agent. The stripping agent can be of any type of stripping agent that is permitted in the field of aeronautics. According to a preferred embodiment, the stripping agent comprises benzyl alcohol, methylene chloride, phenol, benzaldehyde and/or mixtures thereof. Preferably, the stripping agent comprises benzyl alcohol and/or methylene chloride.

The marking device according to the invention comprises a marking layer. The marking layer comprises a marking and a carrier film.

The carrier film can make it possible to opacify the adhesive marking device. It also makes it possible to improve the mechanical and/or thermal resistance of the marking device. It also facilitates the affixing of the marking device on the substrate. Typically, the carrier film comprises an upper side and a lower side.

According to a preferred embodiment, the marking is arranged on the upper side of the carrier film.

According to a preferred embodiment, the carrier film has an MVTR greater than or equal to 50 g/(m²0.24 h) and preferably between 50 and 1500 g/(m²0.24 h). When the marking device comprises a carrier film, the latter is generally the more occlusive. By taking a carrier film of which the MVTR is greater than or equal to 50 g/(m²0.24 h), the permeability of the entire marking device will be sufficient to limit bubbling.

The carrier film can be porous, woven, perforated or made from a permeable material. As such, through the structure thereof, the gases coming from the polymerisation of the paint can easily pass through it. Preferably, the carrier film is made of a permeable or porous material. This type of structure makes it possible to obtain a high MVTR while still retaining good mechanical resistance.

The carrier film can be made of a material chosen from the group comprising polyester, polyurethane, polyether, polyethylene, silicone polymer, polytetrafluoroethylene, polypropylene, polyvinyl chloride, polyolefin, polyalkene, polysulfone, poly(vinyl acetate), poly(vinyl alcohol) and polyamide.

Preferably, the carrier film is chosen from the group comprising urethane, polyester, polyvinyl chloride and silicone. More preferably, the carrier film is made from urethane.

According to an embodiment, the carrier film is made from a permeable material. It is then the material of the carrier film that allows for the breathability of the marking device. The permeable material can for example comprise a polyurethane resin, preferably an aliphatic polyurethane resin.

According to a preferred embodiment, the carrier film has a thickness between 20 μm and 70 μm, preferably between 20 μm and 50 μm. The low thickness of the carrier film allows for better permeability. The thickness of the carrier film is particularly important when the breathability of the marking device is due to the permeability of the carrier film.

According to an embodiment, the carrier film is porous, woven and/or perforated. It is then the structure of the carrier film that allows for the breathability of the marking device.

According to a preferred embodiment, the carrier film is able to be stripped by a stripping agent. The presence of a carrier film makes the removing of the marking device on the substrate even more difficult. The inventors surprisingly observed that it was sufficient for only the carrier film to be able to be stripped in order for the entire marking device to be able to be stripped.

According to a preferred embodiment, the carrier film comprises a resin chosen from the group comprising polyepoxide, polyurethane, alkyd and mixtures thereof. Films supports with a base of these resins are able to be stripped by stripping agents that are permitted in the field of aeronautics, for example conventional stripping agents or with an intermediate layer. The stripping agent can for example be chosen from the group comprising benzyl alcohol, methylene chloride, phenol, benzaldehyde, methylene chloride, alkylphenol ethoxylate, hydrogen peroxide and mixtures thereof.

Preferably, the carrier film comprises a resin chosen from the group comprising polyepoxide, polyurethane and alkyd. These resins are the most commonly used binders for aircraft paint. A marking device of which the carrier film comprises these resins is able to be stripped by the same stripping agents as those of paints that comprise these same resins as a binder. As such, when an operator strips the paint from an aircraft, the marking device will be stripped with the paint because the carrier film thereof contains the same resins and is therefore sensitive to the same stripping agents.

The marking can be carried out by UV cured inks, solvent-based inks, water-based inks, UV cured paints, solvent-based paints, water-based paints. Preferably, the marking is carried out with an ink or a paint of the same nature as that intended to paint the substrate whereon the marking device is to be applied.

According to a preferred embodiment, the marking is a digitally-printed marking, preferably according to a DOD (Drop on Demand) mode. As such, the marking is less occlusive and the gases coming from the polymerisation of the paint can pass through the latter.

The marking device comprises preferably a varnish layer that covers the marking layer. The varnish layer protects the marking layer and in particular the marking. It also allows for a smoothing of the marking layer and good adhesion of aeronautical varnishes.

According to a preferred embodiment, the varnish layer is comprised of silk screened, painted or printed varnish. The varnish can be painted with a spray gun. Preferably, the varnish is printed, preferably via digital printing, preferably by DOD printing. The varnish is more preferably deposited via DOD printing as this technique allows for better permeability.

The varnish can be UV cured varnish or solvent-based varnish.

Preferably, the varnish layer is able to be stripped by a stripping agent. The fact that the varnish layer can also be stripped makes it possible to accelerate the stripping of the marking device when it comprises a varnish layer.

The marking device comprises also an adhesive layer. The marking layer is arranged on the adhesive layer.

Preferably, the lower side of the carrier film is arranged on the adhesive layer. More preferably, the marking is arranged on the carrier film, the carrier film being, itself, arranged on the adhesive layer.

The adhesive layer can be an adhesive layer that is sensitive to pressure or that can be reactivated. Preferably, the adhesive layer is sensitive to pressure.

According to a preferred embodiment, the adhesive layer has a thickness between 25 μm and 50 μm.

The adhesive layer can be protected by a protective sheet.

The marking device can further comprise a handling sheet. The handling sheet is arranged on the upper face of the marking device in such a way as to facilitate the application of the latter. The handling sheet is slightly adhesive.

The invention also relates to a method for manufacturing a marking device according to the invention, characterised in that it comprises the steps of:
supplying a carrier film,
applying a marking on at least one side of the carrier film in such a way as to form a marking layer,
affixing an adhesive layer against the marking layer and
depositing a varnish on the marking layer in such a way as to form a varnish layer.

According to a preferred embodiment, the marking is applied on one side of the carrier film, preferably on the upper side of the carrier film.

Preferably, the method comprises the step of supplying a carrier film having an MVTR between 50 and 1500 g/(m²0.24 h).

According to a preferred embodiment of the method, the application of the marking is carried out by printing, preferably by digital printing, more preferably by DOD. As such, the marking is less occlusive and the MVTR of the marking device can be higher.

The deposition of the varnish is carried out by silk screening and/or by printing. Preferably, the deposition of the varnish is carried out by printing, preferably by digital printing, more preferably by DOD.

According to a preferred embodiment, the adhesive layer is applied on the lower side of the carrier film.

The invention also relates to a method for manufacturing an adhesive marking device for an aircraft, characterised in that it comprises steps of:
supplying a carrier film having an MVTR between 50 and 1500 g/(m²0.24 h),
applying a marking on at least one side of the carrier film in such a way as to form a marking layer,
affixing an adhesive layer against the marking layer, and
depositing a varnish on the marking layer.

Preferably, the marking is applied on one side of the carrier film, preferably the upper side. The upper side of the carrier film is opposite the lower side of the carrier film.

According to a preferred embodiment, the varnish is also deposited on the portions of the upper side of the carrier film whereon no marking is printed.

Preferably, the marking is applied by printing, preferably by digital printing, more preferably by DOD printing.

According to a preferred embodiment, the adhesive layer is applied on the lower side of the carrier film.

Preferably, the deposition of the varnish is carried out by silk screening and/or by printing, preferably by digital printing, more preferably by DOD printing.

The invention also relates to an aircraft comprising a marking device according to the invention.

The invention also relates to the use of a marking device according to the invention for the marking of an aircraft.

### 5. LIST OF FIGURES

Other purposes, characteristics and advantages of the invention shall appear upon reading the following description given solely in a non-limiting manner and which makes reference to the accompanying figures wherein:

FIG. 1 is a cross-section schematic view of a marking device according to an embodiment of the invention.

### 6. DETAILED DESCRIPTION OF AN EMBODIMENT OF THE INVENTION

In the FIGURE, the scales and the proportions are not strictly respected and this, for the purposes of illustration and clarity, in particular the thicknesses are excessively enlarged.

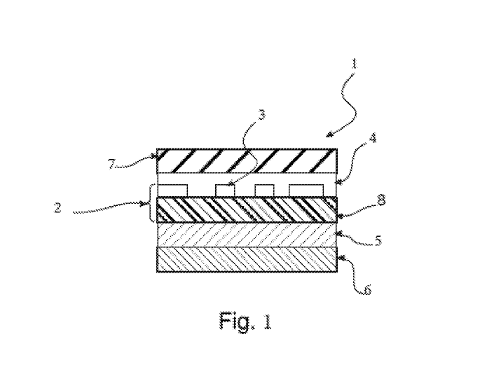

The marking device 1 shown in FIG. 1 comprises a handling sheet 7, a varnish layer 4, a marking layer 2, an adhesive layer 5 and a protective sheet 6.

The marking layer comprises a marking 3 arranged on a carrier film 8. The marking 3 is comprised of an ink with a thickness between 5 and 50 μm. The carrier film 8 is arranged on the adhesive layer 5. The adhesive layer 5 has a thickness between 25 μm and 50 μm. The adhesive layer 5 is covered with a protective sheet 6. The protective sheet 6 is provided in order to be easily removed before the marking device 1 is used. The protective sheet 6 is for example made of silicone paper.

A varnish layer 4 covers the marking 3. The varnish layer 4 also covers the surface of the carrier film 8 that is not covered by the marking 3.

A handling sheet 7 is arranged on the varnish layer 4. The handling sheet 7 is for example made of paper or of semi-transparent polyethylene. It is glued to the varnish layer 4 with an adhesive of which the adhesive power is greater than the adhesive power of the adhesive layer 5 on its protective sheet 6 but much less than the adhesive power of this same adhesive layer 5 on the substrate.

### 7. EXAMPLES

Determination of the Water Vapour Transmission Coefficient

Equipment and Methods

The transmission coefficient of the water vapour of the marking device is determined according to the standard ASTM F 1249 at the temperature of 38° C. and 100% RH.

The measurements are taken with a MOCON PERMETRAN W 3-33 apparatus.

Five marking devices were tested. The first marking device comprises a translucent carrier film made from a permeable material. The second marking device comprises a translucent microporous carrier film. The third marking device comprises a conventional carrier film. The fourth marking device comprises a white carrier film made of permeable material. The fifth device comprises a white microporous carrier film.

For each marking device tested, a sample is placed in a test cell between two chambers at the temperature of 38° C.+/−1° C. The adhesive face of the marking device is placed on the side of the wet chamber (100% RH) and the other facing the contact of the dry chamber swept with dry nitrogen gas with a flow rate of 100 ml/min. The water vapour transmitted through the marking device is analysed by an Infrared detector (analysis of 3 marking devices per reference).

The measures are taken after 30 minutes of stabilisation in situ of the marking device. The calibration of the signal is carried out using a standard film that is “Water Vapour Transmission Reference” certified by NIST. The correct operation of the measurement system is controlled during each series of measurements by the response of a standard film placed in a special chamber provided for this purpose.

Results

The results are expressed in g/(m²*day).

They depend on the thickness. They are therefore also expressed in g*mm/(m²*day)

TABLE 1
MVTR in g/(m²*day)

| | | | | | | | | | Standard |
|---|---|---|---|---|---|---|---|---|---|
| | e1 | Measurement 1 | e2 | Measurement 2 | e3 | Measurement 3 | Mean | Mean | deviation |
| Reference | μm | g/(m²*day) | μm | g/(m²*day) | μm | g/(m²*day) | μm | g/(m²*day) | g/(m²*day) |
| Marking 1 | 156 | 64.4 | 161 | 62.8 | 161 | 54.4 | 159 | 60.5 | 5.4 |
| Marking 2 | 157 | 86.2 | 154 | 88 | 153 | 83.3 | 155 | 85.8 | 2.4 |
| Marking 3 | 130 | 20.1 | 132 | 20.4 | 129 | 20.6 | 130 | 20.4 | 0.3 |
| Marking 4 | 111 | 52.3 | 110 | 53 | 112 | 54.1 | 111 | 53.1 | 0.9 |
| Marking 5 | 125 | 75.7 | 119 | 79.1 | 120 | 68.5 | 121 | 74.4 | 5.4 |

TABLE 2
MVTR in g * mm/(m² * day)

| | | | | | Standard |
|---|---|---|---|---|---|
| | Measurement 1 | Measurement 2 | Measurement 3 | Mean | deviation |
| Reference | g * mm/(m² * day) | g * mm/(m² * day) | g * mm/(m² * day) | g * mm/(m² * day) | g * mm/(m² * day) |
| Marking 1 | 10.0 | 10.1 | 8.8 | 9.6 | 0.8 |
| Marking 2 | 13.5 | 13.6 | 12.7 | 13.3 | 0.5 |
| Marking 3 | 2.6 | 2.7 | 2.7 | 2.7 | 0.1 |
| Marking 4 | 5.8 | 5.8 | 6.1 | 5.9 | 0.1 |
| Marking 5 | 9.5 | 9.4 | 8.2 | 9.0 | 0.7 |

Bubbling Test

Equipment and Methods

Various paints of the base coat or top coat type were applied on a surface used in aeronautics (Aluminium 2024 CLAD, Aviox CF Primer 37124). After a given drying time, the marking devices were affixed onto this surface.

A clear coat was applied over it all. After a given drying time at ambient temperature (Tamb) or at 60° C., the state of the marking device was checked visually, in particular in order to check for the presence of bubbles or cracks.

Results

The results are logged in the table 5 hereinbelow.

No bubbling was observed for marking devices with an MVTR greater than 50 g/(m²·day) following an application on paint which is just dry enough for the application of stencils (“dry to tape”).

In the table hereinbelow, the term “dry to dust” applies to a paint that has just been applied and that appears dry to the touch.

TABLE 3
Bubbling Test

| Paint cycle | | | | | |
|---|---|---|---|---|---|
| Basecoat accelerated | | Basecoat | Basecoat | | |
| Aerobase | | paint cycle | paint cycle | Topcoat paint | Topcoat paint |
| Paint drying time | | Aerobase Dry | Aerobase | cycle 77702 | cycle 77702 |
| 15 min | 25 min | to dust | Dry to tape | Dry to dust | Dry to tape |

| | MVTR | Tamb + 15 min | Tamb + 25 min | Paint drying time at Tamb | | | Paint drying time at Tamb | | | |
|---|---|---|---|---|---|---|---|---|---|---|
| Marking | (g/(m²*day) | T60° C. | T60° C. | 1.5 h | 2 h | 3 h | 2 h | 3 h | 4 h | 5 h |
| 1 | 60.5 | Bubbling | No | Very | No | No | Bubbling | Very | No | No |
| | | | bubbling | fine | bubbling | bubbling | | fine | bubbling | bubbling |
| | | | | bubbling | | | | bubbling | | |
| 2 | 85.8 | No | No | No | No | No | Very | No | No | No |
| | | bubbling | bubbling | bubbling | bubbling | bubbling | fine | bubbling | bubbling | bubbling |
| | | | | | | | bubbling | | | |
| 3 | 20.4 | Strong | Bubbling | Strong | Strong | Bubbling | Strong | Bubbling | Bubbling | Bubbling |
| | | bubbling | | bubbling | bubbling | | bubbling | | | |
| 4 | 53.1 | NR | NR | Very | No | No | Bubbling | Very | No | No |
| | | | | fine | bubbling | bubbling | | fine | bubbling | bubbling |
| | | | | bubbling | | | | bubbling | | |
| 5 | 74.4 | No | No | Very | No | No | Bubbling | Very | No | No |
| | | bubbling | bubbling | fine | bubbling | bubbling | | fine | bubbling | bubbling |
| | | | | bubbling | | | | bubbling | | |

1. An adhesive marking device for an aircraft comprising:
an adhesive layer;
a marking layer arranged on the adhesive layer and comprising a marking and a carrier film; and
a varnish layer that covers the marking layer, wherein the adhesive marking device has a moisture vapour transmission rate (MVTR) greater than or equal to 50 g/(m²·day).

2. An adhesive marking device according to claim 1, wherein the carrier film is made from a permeable material.

3. An adhesive marking device according to claim 1, wherein the carrier film comprises at least one characteristic selected from the group consisting of: porous, woven and perforated.

4. The adhesive marking device according to claim 3, wherein the carrier film is made from a material chosen from the group consisting of: polyester, polyurethane, polyether, polyethylene, silicone polymer, polytetrafluoroethylene, polypropylene, polyvinyl chloride, polyolefin, polyalkene, polysulfone, poly(vinyl acetate), poly(vinyl alcohol) and polyamide.

5. The adhesive marking device according to claim 1, wherein the MVTR is between 50 and 1500 g/(m²·day).

6. The adhesive marking device of claim 1, wherein the adhesive marking device is configured to be stripped by a stripping agent chosen from the group consisting of: benzyl alcohol, methylene chloride, phenol, benzaldehyde, and mixtures thereof.

7. The adhesive marking device of claim 1, wherein the varnish layer is silk screened, painted or printed.

8. The marking device of claim 1, wherein the adhesive layer is sensitive to pressure or can be reactivated.

9. A method for manufacturing the marking device of claim 1, comprising:
supplying a carrier film;
applying a marking on at least one side of the carrier film form a marking layer;
affixing an adhesive layer against the marking layer; and
depositing a varnish on the marking layer to form a varnish layer.

10. A method for manufacturing an adhesive marking device for an aircraft, comprising:
supplying a carrier film having a moisture vapour transmission rate (MVTR) between 50 and 1500 g/(m²·day);
applying a marking on at least one side of the carrier film to form a marking layer;
affixing an adhesive layer against the marking layer; and
depositing a varnish on the marking layer to form a varnish layer.
